(19) United States
(12) Patent Application Publication
(10) Pub. No.: US 2008/0037191 A1
(43) Pub. Date: Feb. 14, 2008

(54) Overvoltage Protection Device with Improved Interrupting Capacity

(76) Inventor: Boris Gautier, Lourdes (FR)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/572,779

(22) PCT Filed: Jul. 25, 2005
(86) PCT No.: PCT/FR05/01915

§ 371 Date: Oct. 9, 2007

(30) Foreign Application Priority Data
Jul. 27, 2004 (FR) 0408304

(51) Int. Cl. H02H 9/06

(52) U.S. Cl. 361/118

(57) ABSTRACT

The invention provides a device for protecting electrical installations against surges caused in particular by a lightning strike, the device comprising:
first and second electrodes (2, 3) between which an electric arc (5) may be generated in a striking area (6);
a device (7) for splitting the electric arc (5) situated at a distance from the striking area (6);
focusing means (9) adapted to define a divergent space (10) for guiding the electric arc (5) from the striking area (6) towards the splitter device (7), said divergent space (10) having an aperture angle (α);
   the device being characterized in that the focusing means (9) are shaped so that the aperture angle (α) of the divergent space (10) increases, on average, between the striking area (6) and the splitter device (7).

### TECHNICAL FIELD

The present invention relates to the general technical field of devices for protecting electrical equipment or installations against voltage disturbances such as surges, and in particular transient surges caused by a lightning strike.

The present invention relates more particularly to a device for protecting electrical installations against surges caused in particular by a lightning strike, the device comprising:
first and second electrodes between which an electric arc may be generated in a striking area;
a device for splitting the electric arc situated at a distance from the striking area; and
focusing means adapted to define a divergent space for guiding the electric arc from the striking area towards the splitter device, said divergent space having an aperture angle;
   the device being characterized in that the focusing means are shaped so that the aperture angle of the divergent space increases, on average, between the striking area and the splitter device.

### PRIOR ART

Devices for protecting electrical installations against surges are widely used and may commonly be referred to as “lightning arresters”. Their essential purpose is to ground lightning currents and possibly to peak limit the additional voltages induced by these currents to levels compatible with the withstand voltages of the equipment and apparatus to which they are connected.

Using a spark gap lightning arrester to protect an installation against surges is already known in the art. The spark gap is then located between the phase to be protected and ground, for example, in order to ground the lightning current in the event of a surge.

A spark gap is a well-known device comprising two facing electrodes separated by an insulative medium. One of the electrodes is electrically connected to the phase to be protected, for example, and the other electrode is grounded. If a surge generated by a lightning current reaches a threshold value called the triggering value, the spark gap is triggered and an electric arc is formed between the electrodes, in an area called the striking area, thereby creating a short-circuit between the phase and ground. The lightning current then flows from the phase to ground and the electrical installation is protected.

The electric arc is not extinguished spontaneously and a short-circuit current called the secondary current therefore continues to flow. To prevent the installation from being powered down, this secondary current should preferably be interrupted without causing the general interrupter devices of the installation, such as circuit-breakers, to open.

For this reason, the protection devices known in the art often include a current interrupter device adapted to interrupt a high current. This interrupter device generally comprises an arc splitter device (or interrupter chamber) taking the form of spaced parallel metal plates adapted to divide the electric arc into a plurality of small individual arcs in order to extinguish the arc and thereby interrupt the secondary current.

The protection devices known in the art are also often provided with focusing means for guiding the propagation of the electric arc from the striking area to the splitter device. These focusing means can take the form of two branches facing each other in a “V” shape. The arc is then struck at the base of the V and the parallel splitter plates are disposed between the ends of the branches of the V opposite the base.

The lightning current conduction capacities of a spark gap lightning arrester are known to be optimized when the angle of the “V” shape formed by the focusing means is small. Also, the efficacy of the arc splitter device is known to be proportional to the number of splitter plates.

The structure of the devices described above therefore imposes positioning the interrupter device, i.e. the arc splitter plates, at a sufficient distance from the base of the “V” shape to enable them to be accommodated between the ends of the branches of the “V” shape at the same time as retaining an optimum relatively small aperture angle of the “V” shape.

Such devices, although of interest because of their particularly simple design, have a number of drawbacks, however, linked in particular to their limited secondary current interruption capacity.

In fact, if a large number of splitter plates is necessary to break the secondary current effectively, for example if the AC line voltage is high, the structure of the devices described above has the effect of significantly increasing the distance that the electric arc has to travel to reach the splitter plates.

This therefore has the effect not only of increasing the dimensions of the protection device but also of slowing down the propagation of the arc and delaying its entry into the interrupter device.

The efficacy of the interrupter device depends not only on the number of splitter plates but also on the speed with which the arc enters the interrupter chamber after it is formed.

For this reason, prior art protection devices are not fully effective for high AC line voltages when a large number of splitter plates is necessary for the arc voltage to rise above the AC line voltage and enable the current to be interrupted.

### SUMMARY OF THE INVENTION

The objects of the invention are therefore aimed at removing the various drawbacks set out above and proposing a new device for protecting electrical installations against surges provided with a more effective interrupter device.

Another object of the invention aims to propose a new device of limited overall size for protecting electrical installations against surges.

A further object of the invention aims to propose a new device for protecting electrical installations against surges, in which the structure of the device is particularly adapted to high AC line voltages.

A further object of the invention aims to propose a new device for protecting electrical installations against surges, in which the focusing means of the device are specifically adapted to facilitate and to accelerate the propagation of the electric arc.

A further object of the invention aims to propose a new surge protection device that reduces the propagation time of the electric arc between the area in which it is formed and the area in which it is extinguished.

The objects of the invention are achieved by a device for protecting electrical installations against surges caused in particular by a lightning strike, the device comprising:
first and second electrodes between which an electric arc may be generated in a striking area;
a device for splitting the electric arc situated at a distance from the striking area; and
focusing means adapted to define a divergent space for guiding the electric arc from the striking area towards the splitter device, said divergent space having an aperture angle;
   the device being characterized in that the focusing means are shaped so that the aperture angle of the divergent space increases, on average, between the striking area and the splitter device.

### BRIEF DESCRIPTION OF THE DRAWINGS

Other features and advantages of the invention become apparent and emerge in more detail on reading the following description with reference to the appended drawings, which are provided by way of purely illustrative and non-limiting example, in which drawings:

FIG. 1 is a view in section of one embodiment of a surge protection device in accordance with the invention.

FIG. 2 is a view in section of one embodiment of the focusing means of the protection device in accordance with the invention.

FIG. 3 is a view in section taken along the line A-A in FIG. 1 of a detail of the surge protection device in accordance with the invention.

FIG. 4 is a view in section of another embodiment of the focusing means of the protection device in accordance with the invention.

### PREFERRED EMBODIMENT OF THE INVENTION

The surge protection device in accordance with the invention is intended to shunt the electrical equipment or installation that is to be protected. The expression “electrical installation” refers to any type of apparatus or network liable to suffer voltage disturbances, in particular transient surges caused by lightning.

The surge protection device in accordance with the invention is advantageously intended to be disposed between one phase of the installation to be protected and ground.

Without departing from the scope of the invention, it may also be envisaged that, instead of shunting one phase to ground, the device be connected between neutral and ground, between one phase and neutral or between two phases (differential protection).

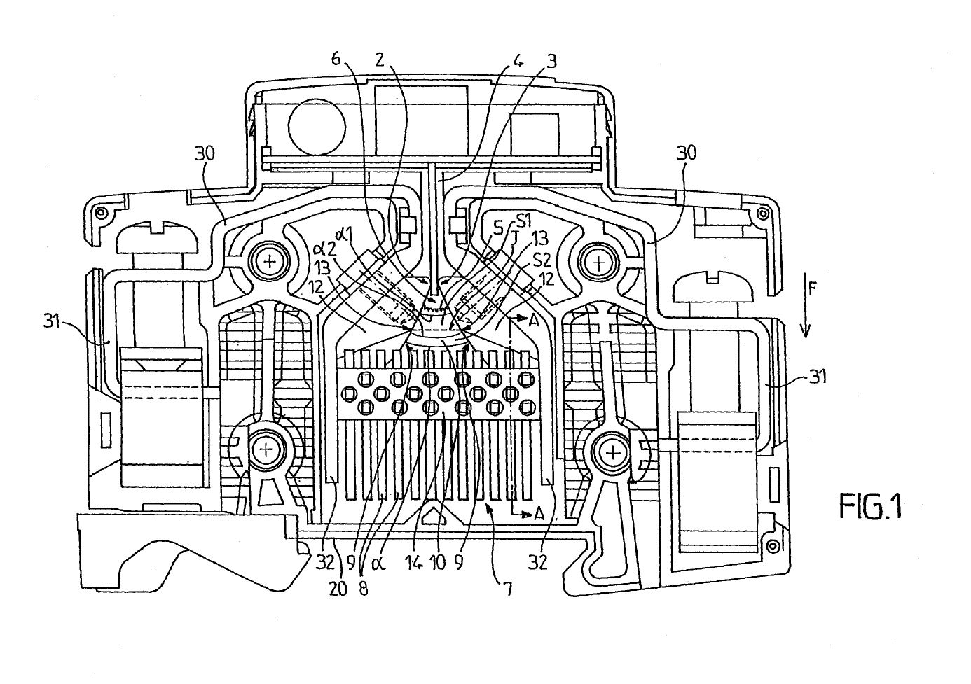

FIG. 1 shows a protection device 1 in accordance with the invention, advantageously taking the form of a lightning arrester incorporating a spark gap. The protection device 1 comprises a first electrode 2 and a second electrode 3 adapted to form the two main electrodes of the spark gap lightning arrester, as shown in FIG. 1. Each of the electrodes 2, 3 is advantageously connected connection means 30 of electrically conductive material to the phase of the installation to be protected and to ground. The electrodes 2, 3 are held at a distance apart from each other and are separated by a dielectric material sheet 4 enabling an electric arc 5 to be struck between the electrodes 2, 3. This portion of the device therefore constitutes the striking area 6 of the electric arc 5.

According to the invention, the protection device 1 also includes a device 7 for interrupting or splitting the electric arc 5, including at least one and preferably several parallel metal splitter plates 8. To this end, the plates are preferably held at a distance apart from each other by insulative material supports 14. The splitter plates 8 are intended to split the electric arc into a plurality of individual arcs in order to increase the arc voltage.

The connection means 30 advantageously have a proximal portion 31 specifically designed and shaped to be connected to the electrical installation and a distal portion 32 that preferably extends substantially parallel to the splitter plates 8 to constitute a lateral border for the splitter device 7. Thus the splitter device 7 is preferably disposed between the distal portions 32 of the connection means 30. The connection means further include an intermediate portion 33 disposed between the striking area 6 and the splitter device 7.

Interruption of the current and in particular interruption the secondary current of the spark gap is obtained when the arc voltage is higher than the AC line voltage. Since the arc voltage is directly proportional to the number of splitter plates, the efficacy of the interrupter device is therefore directly proportional to the number of splitter plates. Accordingly, the higher the AC line voltage, the greater the number of splitter plates 8 required. For example, for an AC line voltage of 230 V, around ten to fifteen splitter plates 8 are required to obtain satisfactory splitting of the electric arc.

According to the invention, the splitter device 7 is situated at a distance from the striking area 6 such that, to be split, the electric arc 5 must first propagate in the insulative medium situated between the striking area 6 and the splitter device 7.

To facilitate propagation of the electric arc 5 in the propagation direction F shown in FIG. 1, the protection device 1 includes focusing means 9 adapted to define a divergent space 10 for guiding the electric arc 5 from the striking area 6 towards the splitter device 7.

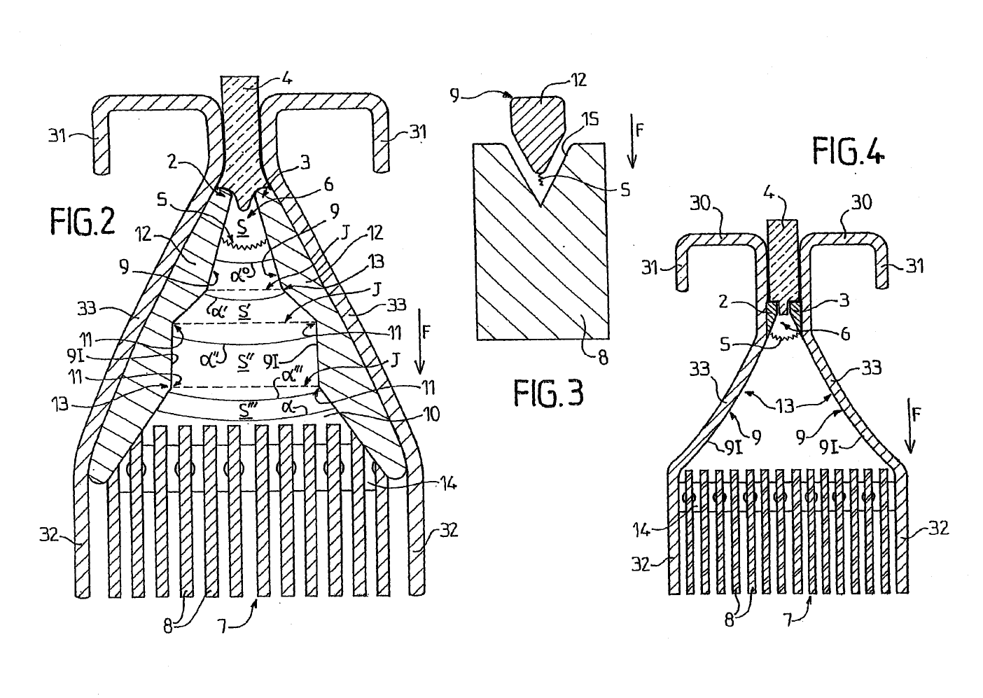

As shown in FIGS. 1 and 2, the divergent space 10 has an aperture angle α that characterizes the aperture of the focusing means 9.

The electrodes 2, 3, the splitter device 7, and the focusing means 9 are advantageously disposed in a housing 20 (FIG. 1) that is preferably not sealed so that gases generated by the electric arc 5 can be evacuated.

According to an essential feature of the invention, the focusing means 9 are shaped so that the aperture angle α of the divergent space 10 increases, on average, between the striking area 6 and the splitter device 7.

The expression “on average” refers to the possibility of the aperture angle α varying along the focusing means 9, for example increasing, then decreasing, then increasing again, so that near the splitter device 7 the aperture angle α of the divergent space 10 is substantially greater than the aperture angle of the same space near the striking area 6 (FIG. 2). It may therefore be considered that, on average, the aperture angle α of the divergent space 10 increases between the striking area 6 and the splitter device 7.

As shown in FIG. 2, the aperture angle α of the divergent space 10 may vary discontinuously between the striking area 6 and the splitter device 7. In other words, this means that under such circumstances the focusing means 9 have, on the same side as the divergent space 10, sharp edges 11 at which there occurs a discontinuity in the inclination of the focusing means 9.

The focusing means 9 are preferably shaped so that the aperture angle α of the divergent space 10 varies continuously between the striking area 5 and the splitter device 7. This kind of configuration prevents the sharp edges 11 attracting the electric arc 5, thereby impeding its advance.

It is even more preferable if the aperture angle α of the divergent space 10 varies in a non-linear manner between the striking area 6 and the splitter device 7. In other words, there is preferably no relationship of proportionality between the aperture angle α and the distance to the striking area 6. It is nevertheless clearly feasible, in certain situations, to shape the focusing means 9 so that the aperture angle α of the divergent space 10 varies in a linear manner.

As shown in FIG. 2, the focusing means 9 are preferably shaped to define a plurality of staggered and successively juxtaposed angular sectors S, S′ or S″, S′″ between the striking area 6 and the splitter device 7.

Accordingly, two successive angular sectors S, S′ or S″, S′″ advantageously have different aperture angles α°, α′ or α″, α′″. It is even more preferable if the aperture angle α°, α′, α″, α′″ of the same angular sector S, S′, S″, S′″ is substantially constant. Nevertheless, it is clearly feasible, without departing from the scope of the invention, for the focusing means 9 to be such that the aperture angle of the same angular sector varies continuously. Under such circumstances, there is preferably a discontinuity (or a sudden although not discontinuous) variation in the aperture angle of the divergent space 10 at the junction J between two successive angular sectors (shown in dashed line in FIG. 2).

In an even more preferable embodiment of the invention, shown in FIG. 1, the focusing means 9 are preferably shaped to define an upstream first angular sector S1 having a first aperture angle α1 and a downstream second angular sector S2 having a second aperture angle α2 greater than the first aperture angle α1. The terms “upstream” and “downstream” refer to the direction F of propagation of the electric arc 5 from the striking area 6 towards the splitter device 7.

Accordingly, the upstream first angular sector S1 is situated near the striking area 6 and the downstream second angular sector S2 is in contrast situated near the splitter device 7. In this embodiment, the first and second aperture angles α1, α2 are preferably constant in each of the sectors S1, S2.

Also, the first aperture angle α1 is preferably from 30° to 45° and preferably of the order of 30°, to optimize the flow of the lightning current. In contrast, the second aperture angle α2 is greater than the first aperture angle α1 and its value is directly linked to the number of splitter plates 8. Accordingly, the higher the number of splitter plates 8, the larger the aperture angle α2. The second aperture angle α2 is preferably greater than 90°.

In a preferred embodiment of the invention, shown in FIGS. 1 and 2, the focusing means 9 have a substantially elongate shape and are preferably formed by two elongate electrically conductive material parts or part portions 12. It is even more preferable if the focusing means 9 are formed by the electrodes 2, 3, which take the form of elongate parts 12. The elongate parts or part portions 12 therefore advantageously form two branches and face each other and are inclined relative to each other, thereby defining the divergent space 10.

In another embodiment of the invention, shown in FIG. 4, the focusing means 9 are formed by the substantially elongate intermediate portions 33 of the connection means 30, said intermediate portions 33 then forming the elongate part portions. In this embodiment, the connection means 30 are preferably shaped so that their intermediate portion 33 is in line with and continuous with the electrodes 2, 3. The electrodes 2, 3 are then formed by two conductive parts independent of the focusing means 9. In a further embodiment of the invention, not shown in the figures, the electrodes 2, 3, the focusing means 9, and the connection means 30 are separate parts.

The focusing means 9, for example the elongate parts or the intermediate portions 33 of the connection means 30, preferably have, along their length, at least one inclination discontinuity area 13 situated substantially at the junction between two consecutive angular sectors S1, S2, S, S′, S″, S′″.

The inclination discontinuity area 13 is advantageously situated on the internal surface 9I of the focusing means 9, said internal surface 9I being in contact with the insulative medium of the divergent space 10.

As shown in FIG. 1, it is even more preferable for the inclination discontinuity area 13 to be substantially rounded to prevent the propagation of the electric arc 5 from being impeded or slowed down by the presence of sharp corners in this area.

A further embodiment of the invention, which moreover constitutes a separate invention, is described next with reference to FIGS. 1 to 3.

In this embodiment, as shown in FIG. 3, each splitter plate 8 is preferably provided with a notch 15 intended to facilitate the penetration of the electric arc 5 into the splitter device 7. This notch 15 is therefore open on the same side as the divergent space 10 and, in a manner that is particularly advantageous, the focusing means 9, for example the elongate parts 12, are shaped to be accommodated within the notch 15. To this end, the section of the focusing means 9 may have a tapered, for example pointed, shape substantially complementary to the shape of the notch 15, at least in the portion intended to be accommodated inside the notch 15. This kind of configuration means that the focusing means 9 may be moved even closer to the splitter device 7, therefore increasing the overall efficacy of the interrupter device.

The operation of the protection device 1 in accordance with the invention is described next with reference to FIGS. 1 to 3.

When the protection device 1 is installed, shunting the electrical installation to be protected, and a lightning strike occurs, for example, generating a lightning current and creating a surge exceeding a predetermined threshold value, an electric arc 5 is formed between the two electrodes 2, 3 in the striking area 6. Because of the small aperture angle a of the focusing means 9 in the striking area 6, the protection device 1 in accordance with the invention enables the lightning current to flow quickly and efficiently. The electric arc 5 is then guided, with the aid of the focusing means 9, towards the splitter device 7 in order to enable interruption of the secondary current.

Because of the controlled opening of the focusing means 9, the structure of the protection device 1 in accordance with the invention means that the number of splitter plates 8 can be increased without increasing the distance between the striking area 6 of the electric arc 5 and the splitter device 7. This structure therefore has the advantage of maintaining a constant efficacy of the interrupted device independently of the number of splitter plates used, and therefore independently of the AC line voltage.

### SUSCEPTIBILITY OF INDUSTRIAL APPLICATION

The invention finds its industrial application in the design, manufacture, and use of surge protection devices.

1. A device for protecting electrical installations against surges caused by a lightning strike, comprising:
a) first and second electrodes between which an electric arc may be generated in a striking area;
b) a splitter device for splitting the electric arc situated at a distance from the striking area; and
c) focusing means adapted to define a divergent space for guiding the electric arc from the striking area towards the splitter device,
wherein the divergent space having an aperture angle;
the focusing means are shaped so that the aperture angle of the divergent space increases, on average, between the striking area and the splitter device.

2. The device of claim 1, wherein the aperture angle of the divergent space varies discontinuously between the striking area and the splitter device.

3. The device of claim 1, wherein the aperture angle of the divergent space varies continuously between the striking area and the splitter device.

4. The device of claim 3, wherein the aperture angle of the divergent space varies in a non-linear manner between the striking area and the splitter device.

5. The device of claim 1, wherein the focusing means are shaped to define a plurality of angular sectors successively juxtaposed between the striking area and the splitter device so that two successive angular sectors have different aperture angles.

6. The device of claim 5, wherein the aperture angle of the same angular sector is substantially constant.

7. The device of claim 5, wherein the aperture angle of the same angular sector varies continuously.

8. The device of claim 5, wherein the focusing means are shaped to define an upstream first angular sector having a first aperture angle, and a downstream second angular sector having a second aperture angle greater than the first aperture angle.

9. The device of claim 8, wherein the first aperture angle is from about 30° to about 45°.

10. The device of claim 8, wherein the second aperture angle is greater than about 90°.

11. The device of claim 5, wherein the focusing means are formed by two electrically conductive material elongate parts or part portions facing each other and inclined to each other and the elongate parts have, along their length, at least one inclination discontinuity area situated substantially at the junction between two consecutive angular sectors.

12. The device of claim 11, wherein the inclination discontinuity area is substantially rounded.

13. The device of claim 1, wherein the arc splitter device includes a splitter plate provided with a V-shaped notch adapted to facilitate penetration of the electric arc into the splitter device, the focusing means are shaped to be accommodated within the notch.

14. The device of claim 1, formed by a spark gap lightning arrester.

15. The device of claim 1, wherein the focusing means are formed by the electrodes.

16. The device of claim 2, wherein the focusing means are shaped to define a plurality of angular sectors successively juxtaposed between the striking area and the splitter device so that two successive angular sectors have different aperture angles.

17. The device of claim 3, wherein the focusing means are shaped to define a plurality of angular sectors successively juxtaposed between the striking area and the splitter device so that two successive angular sectors have different aperture angles.

18. The device of claim 4, wherein the focusing means are shaped to define a plurality of angular sectors successively juxtaposed between the striking area and the splitter device so that two successive angular sectors have different aperture angles.

19. The device of claim 6, wherein the focusing means are shaped to define an upstream first angular sector having a first aperture angle and a downstream second angular sector having a second aperture angle greater than the first aperture angle.

20. The device of claim 7, wherein the focusing means are shaped to define an upstream first angular sector having a first aperture angle and a downstream second angular sector having a second aperture angle greater than the first aperture angle.

21. The device of claim 8, wherein the first aperture angle is preferably 30°.

22. The device of claim 9, wherein the second aperture angle is greater than 90°.
